(19) United States
(12) Patent Application Publication
(10) Pub. No.: US 2025/0350216 A1
(43) Pub. Date: Nov. 13, 2025

(54) MOTOR REBOOT AFTER SHUTDOWN IN FLIGHT

(71) Applicant: BETA AIR, LLC, South Burlington, VT (US)

(72) Inventor: Tyler Arsenault, Cambridge, VT (US)

(21) Appl. No.: 18/661,279

(22) Filed: May 10, 2024

(51) Int. Cl. H02P 6/16; B64C 29/00; B64D 31/16; H02P 6/28

(52) U.S. Cl. CPC H02P 6/16; B64D 31/16; H02P 6/28; B64C 29/0008

(57) ABSTRACT

An electrically powered aircraft is configured to reboot its motor(s) while in flight when the motor(s) are deenergized and/or stop spinning. A controller may receive one or more measurements associated with the motor, such as phase voltage measurements. The phase voltage measurements may be used to determine a position or angle of the motor, such as the position of the rotor of the motor to the stator of the motor. The phase voltage of the motor arises due to back-EMF from the spinning, but unpowered, motor. The motor position can then be used to by the controller to synchronize an inverter and provide synchronized command signals to the motor to restart the motor. If the motor is not spinning or not spinning fast enough to reliably determine its position, then an open-loop start may be used to spin up the motor prior to measuring the phase voltages for synchronization.

### TECHNICAL FIELD

The present disclosure relates to rebooting or restarting a motor after the motor stops operating. More specifically, the present disclosure relates to restarting a motor of an electric aircraft while the aircraft is in flight or otherwise operational.

### BACKGROUND

In electrically propelled vehicles, such as an electric vertical takeoff and landing (eVTOL) aircraft, it is essential to maintain the integrity and safe operation of the components of the aircraft until safe landing. If one or more components, such as a motor, malfunctions or stops operating, the safety of the eVTOL, along with those onboard, may be compromised. In some cases, environmental or other factors may lead to the malfunction of one or more components of an eVTOL aircraft. For example, providing power to one or more motors may be interrupted while in flight, leading to an unsafe flight condition. The disclosure herein addresses this and other flight safety issues.

### SUMMARY

In an aspect of the present disclosure, a motor controller includes one or more processors and one or more computer-readable media storing computer-executable instructions that, when executed by the one or more processors, cause the one or more processors to determine that a motor is lacking commutation. The one or more processors further determine that the motor is to be commutated, receive, from one or more voltage sensors, a first phase voltage value associated with a first phase of the motor, and receive, from the one or more voltage sensors, a second phase voltage value associated with a second phase of the motor. The one or more processors still further determine, based at least in part on the first phase voltage value and the second phase voltage value, a motor position associated with the motor, generate, based at least in part on the motor position, current control signals for one or more switches, wherein the one or more switches generate commutation signals for the motor, and provide the current control signals to the one or more switches.

In another aspect of the present disclosure, a method includes determining, by a motor controller, that a motor is lacking commutation, receiving, by the motor controller and from one or more voltage sensors, a first phase voltage value associated with a first phase of the motor, and determining, by the motor controller and based at least in part on the first phase voltage value, a motor speed of the motor. The method further includes determining, by the motor controller, that the motor speed is less than a threshold speed and determining, by the motor controller and based at least in part on the motor speed being less than the threshold speed, that the motor is to be operated in open loop operation. The method still further includes generating, by the motor controller, current control signals for open loop operation of the motor and providing, by the motor controller and to one or more switches, the current control signals, wherein the one or more switches generate commutation signals to power the motor based at least in part on the current control signals.

In yet another aspect of the present disclosure, an aircraft includes a flight controller, a motor assembly including a motor, one or more switches configured to provide commutation signals to the motor, and a motor controller configured to control the motor assembly, and one or more voltage sensors communicatively coupled to the motor controller. The motor controller is configured to receive an enable signal from the flight controller indicating that the motor is to be commutated and determine that the motor is lacking commutation. The motor controller is further configured to receive, from the one or more voltage sensors, a first phase voltage value associated with a first phase of the motor and receive, from the one or more voltage sensors, a second phase voltage value associated with a second phase of the motor. The motor controller is still further configured to generate, based at least in part on the first phase voltage value and the second phase voltage value, current control signals for the one or more switches, wherein the one or more switches generate commutation signals for the motor based at least in part on the current control signals and provide the current control signals to the one or more switches.

### BRIEF DESCRIPTION OF DRAWINGS

FIG. 1 is a block diagram of an example electric vertical takeoff and landing (eVTOL) aircraft, according to examples of the disclosure.

FIG. 2 is a schematic illustration of an example motor assembly of the eVTOL aircraft of FIG. 1, according to examples of the disclosure.

FIG. 3 is a flow diagram depicting an example method for rebooting a motor of the eVTOL aircraft of FIG. 1, according to examples of the disclosure.

FIG. 4 is a block diagram depicting another example method for rebooting a motor of the eVTOL aircraft of FIG. 1, according to examples of the disclosure.

FIG. 5 is a signal timing diagram depicting various signals involved in rebooting a motor of the eVTOL aircraft of FIG. 1, according to examples of the disclosure.

FIG. 6 is a block diagram of a controller of inverter of the eVTOL aircraft of FIG. 1, according to examples of the disclosure.

### DETAILED DESCRIPTION

Wherever possible, the same reference numbers will be used throughout the drawings to refer to the same or like parts.

The disclosure herein is directed to systems, methods, and apparatus for rebooting a motor. In examples of the disclosure, the motor may be in a vehicle, such as an aircraft, such as an electric vertical takeoff and landing (eVTOL) aircraft and/or in a conventional takeoff and landing (CTOL) aircraft. Although disclosed in the context of an eVTOL aircraft, it should be understood that the disclosure herein may be applied to any situation where a motor is being rebooted or reengaged after an intentional or unintentional stoppage. For example, if one of a plurality of motors of an eVTOL aircraft were to stop or be unpowered, for whatever reason during flight, the disclosure herein allows for the motor to be rebooted or restarted relatively quickly. In examples, the stopped motor may be restarted in a manner that causes little or no impact on the flight of the eVTOL aircraft.

According to the disclosure, a motor that is no longer powered during flight may be restarted by measuring voltage(s) and/or current(s) of the motor, while the motor is spinning. In other words, although the motor is no longer powered, the motor may still be spinning due to inertia from a time when the motor was powered. While the motor is spinning, the phase voltages of the motor may be measured to determine the position of the motor's rotor relative to its stator. Once the motor's position is known, the motor may be restarted with proper timing of power provided to each of the phases of the motor. In this mechanism, the motor may again be powered by synchronizing the motor control and power delivery to the position of the motor. If the motor is not spinning fast enough, then the motor may first be spun up prior to engaging in the process of synchronizing the power delivery to the motor to the position and/or motion of the motor.

It should be understood that the mechanism disclosed herein may be utilized when a motor is rendered unpowered during the use of the motor. For example, an eVTOL aircraft may be in flight when a motor is to be reboot. The motor and its corresponding inverter, providing power via commutation signals, may become unsynchronized due to a variety of reasons, such as electromagnetic noise. When the supply of power from the inverter to the motor is disrupted, particularly during flight of the eVTOL aircraft, the eVTOL may lack adequate levels of lift and/or thrust, presenting a safety concern. Thus, the disclosure herein may be implemented to reboot the motor for synchronized or closed loop operation to mitigate any safety issues resulting from a motor becoming unpowered during flight.

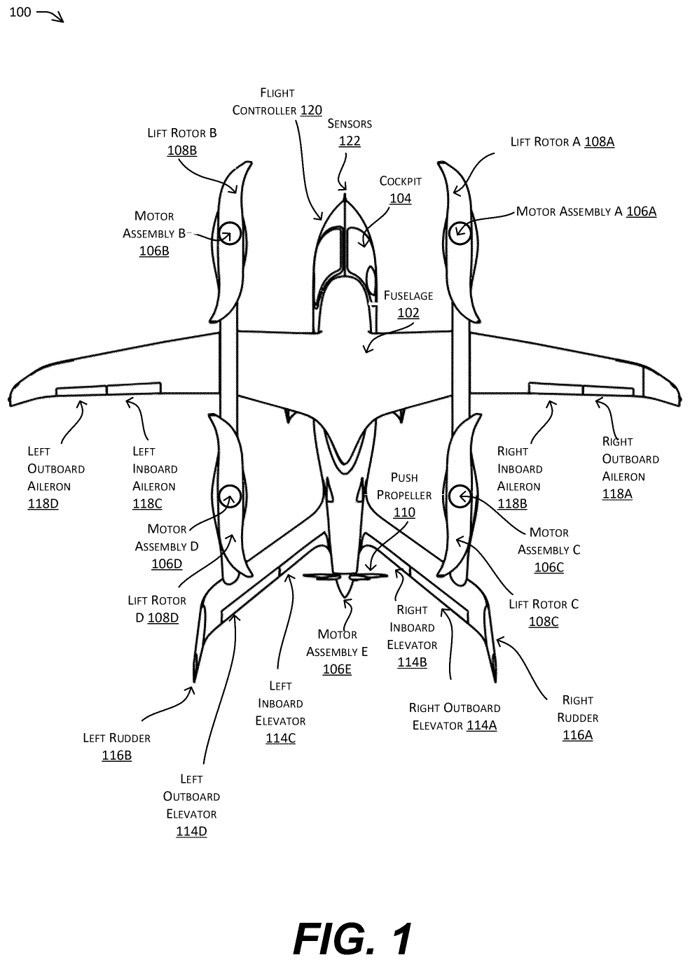

FIG. 1 is a block diagram of an example electric vertical takeoff and landing (eVTOL) aircraft 100, according to examples of the disclosure. The aircraft 100 includes a fuselage 102 and a cockpit 104 to carry passengers and/or a pilot. In alternate cases, the aircraft 100 may be unmanned and controlled remotely. In some cases, the aircraft 100 may have a fly-by-wire control system.

Although, discussed in the context of an eVTOL aircraft 100, it should be understood that the disclosure herein may be applied to any use case where a motor, such as a permanent magnet synchronous motor (PMSM), is to be rebooted in a safe and reliable manner. Thus, the disclosure may be applied to any variety of transportation applications, such as electric watercrafts, electric cars, electric heavy machinery, electric trucks, electric trains, electric busses, or the like. The disclosure herein may also be applied outside of the realm of transportation, such as in appliances, power tools, or the like.

The aircraft 100 may include motor assembly A 106A, motor assembly B 106B, motor assembly C 106C, motor assembly D 106D, and motor assembly E 106E, hereinafter referred to in the singular as motor assembly 106 or in the plural as motor assemblies 106. The motor assemblies 106 may be positioned to balance thrust and/or lift distribution across the aircraft 100. In some embodiments, one or more of the motor assemblies 106 may be configured for redundancy or for failover purposes. For example, in some cases, if motor assembly A 106A were to fail and/or operate at a reduced capacity, a set of other motor assemblies (e.g., motor assembly B 106B, motor assembly C 106C, and/or motor assembly D 106D) may be configured to compensate for the reduced and/or lost operational capacity of motor assembly A 106A.

The motor assemblies 106 may be configured to drive (e.g., rotate) one or more propulsors, such as lift rotors 108A, 108B, 108C, 108D, hereinafter referred to in the singular as lift rotor 108 or in the plural as lift rotors 108, and/or a push propeller 110. For example, motor assembly A 106A may be configured to drive the lift rotor A 108A, motor assembly B 106B may be configured to drive the lift rotor B 108B, motor assembly C 106C may be configured to drive the lift rotor C 108C, motor assembly D 106D may be configured to drive the lift rotor D 108D, and motor assembly E 106E may be configured to drive the push propeller 110. In some examples, lift rotors 108 may be configured to enable the vertical takeoff of the aircraft 100, while the push propeller 110 may be configured to enable the horizontal movement of the aircraft.

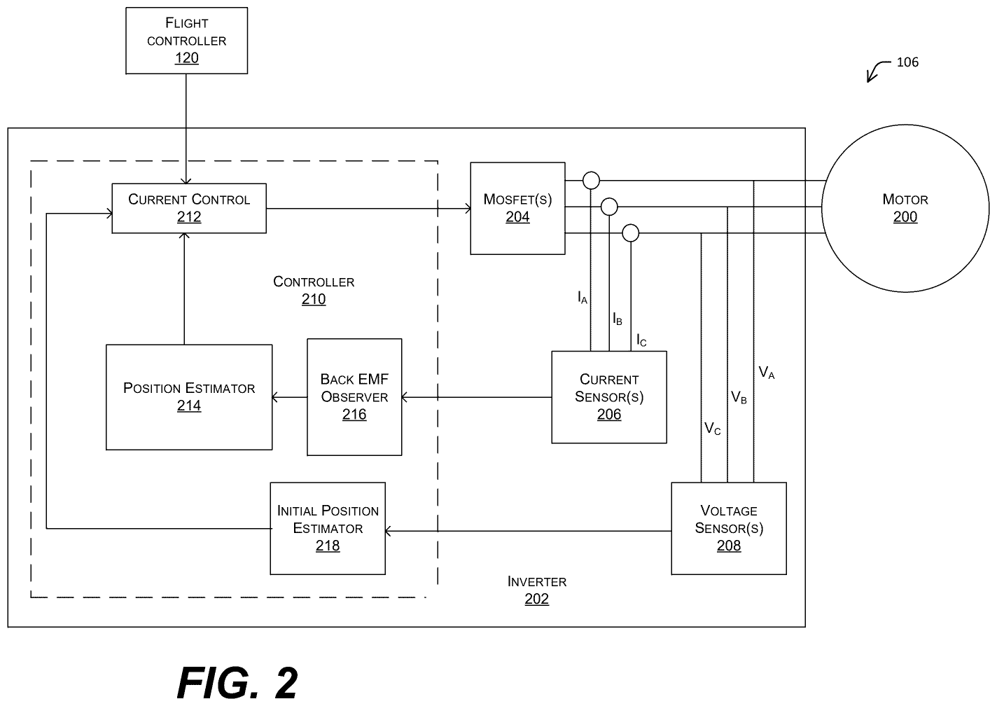

The motor assemblies 106 may include an electric motor and associated hardware and software to control the operation of the motor assemblies 106, as will be discussed in conjunction with FIG. 2. The aircraft 100 may include one or more energy sources such as one or more batteries (not shown) to store electric energy that is used to energize the motor assemblies 106 to drive their corresponding lift rotors 108 and/or push propeller(s) 110. For example, a battery may store electrical energy and provide that energy, as controlled by the components of the motor assembly 106 to provide direct current (DC) electric power to power motors of the motor assemblies 106 to rotate the corresponding lift rotors 108 and/or push propeller 110. The motor assemblies 106 may operate at any suitable voltage, current, and/or power. For example, the motor assemblies may operate in a voltage range of about 25 volts to about 500 volts and a current range of about 10 Amps to about 100 Amps. In some cases, the operating voltage range of about 50 volts to about 300 volts and a current range of about 20 Amps to about 40 Amps. An inverter, as discussed further in conjunction with FIG. 2, may convert the DC electric power stored by a battery into alternating current (AC) power and/or pulse width modulated (PWM) power and provide the AC and/or PWM power to the motors in each of the motor assemblies 106 as commutation signals.

The aircraft 100 includes a set of control surfaces, such as a right outboard elevator 114A, right inboard elevator 114B, left inboard elevator 114C, and left out board elevator 114D, hereinafter referred to in the singular as elevator 114 or in the plural as elevators 114. The elevators 114 are configured to control the pitch of the aircraft 100. In some cases, the elevators 114 on both sides of the aircraft 100 may be partitioned into two or more components to provide more precise control over the pitch of the aircraft 100 and/or to provide redundancy in the event of any component failure. For example, in some embodiments, having two or more elevators 114 on each side enables independently controlling those elevators 114 to enable more fine-tuned control over the pitch of the aircraft 100. Additionally, in the event of failure of a first elevator 114 on one side, a second elevator 114 on the same side may enable control of the pitch of the aircraft 100 on that side to mitigate the effects of the failure.

Additional control surfaces of the aircraft 100 include a right rudder 116A and left rudder 116B, hereinafter referred to in the singular as rudder 116 or in the plural as rudders 116, to control yaw of the aircraft 100. Although, unlike the elevators 114, the rudders 116 of the aircraft 100 are not depicted as partitioned on two sides it should be understood that in some airframe embodiments, the rudders 116 of the aircraft 100 may be partitioned on one or both sides. Still further, the aircraft 100 may include a right outboard aileron 118A, a right inboard aileron 118B, a left inboard aileron 118C, and a left outboard aileron 118D, hereinafter referred to in the singular as aileron 118 or in the plural as ailerons 118, to generate lift or drag. Any of the control surfaces 114, 116, 118 may be of more or less numbers and may be controlled by a pilot, a remote operator, or a bot, either directly or indirectly (e.g., fly-by-wire). Each of the control surfaces 114, 116, 118 may be controlled using one or more actuators (not shown).

As further depicted in FIG. 1, the aircraft 100 includes a flight controller 120. The flight controller 120 may include one or more flight controller components (e.g., one or more flight control computers (FCCs)) configured to generate command signal(s) that control the operation of various components of the aircraft 100. For example, the flight controller unit 120 may be configured to generate command signal(s) that control the operation of one or more inverters that provides electrical power and/or commutation within the motor assemblies 106 of the aircraft 100, an actuator that controls the operation of at least one control surface 114, 116, 118 of the aircraft 100, and/or the like.

A pilot (not shown) or other operator of the aircraft 100 may be in the cockpit 104 of the aircraft 100 to control the operation (e.g., speed, direction, altitude, etc.) of the aircraft 100. The pilot may interact with a variety of control devices (not shown) within the cockpit 104 to control the actions of the aircraft 100. The control devices may be configured to detect a pilot action and transmit pilot input data representing a desired action of the aircraft 100 (e.g., an electrical signal encoding the detected desired action) to the flight controller 120. A pilot control device may include a throttle lever, an inceptor stick, a lift lever, a steering wheel, a brake pedal, a pedal control, a toggle, a joystick, a collective pitch control device, an alpha-numeric input device (e.g., a keyboard), a pointing device, an audio input device (e.g., a microphone, a voice response system, etc.), a cursor control device (e.g., a mouse), a touchpad, an optical scanner, a video capture device, a touchscreen, and/or the like.

The flight controller 120 may identify inputs from the pilot and/or remote operator via one or more control devices and use those inputs to control various components of the aircraft 100. The aircraft 100 may perform the actions desired by the pilot and/or remote operator by way of commands generated by the flight controller 120 to move control surfaces 114, 116, 118 and/or control the motor assemblies 106. In some cases, the flight controller 120 may also receive signals from sensor(s) 122. The sensors 122 may provide a variety of information to the controller 120, such as location (e.g., latitude, longitude, altitude, etc.), obstructions, temperature, humidity, other environmental factors, etc. The flight controller 120 may be configured to change the operation of the aircraft 100 responsive to signals from the sensors 122.

The flight controller 120 may include a microprocessor, a digital signal processor (DSP), a system on a chip (SoC), a field-programmable gate array (FPGA), a complex programmable logic device (CPLD), an application specific integrated circuit (ASIC), a multi-chip module, a printed circuit board, and/or the like. In some embodiments, the flight controller 120 is configured to receive one or more pilot input signals from one or more pilot control devices, perform one or more signal processing operations (e.g., one or more time-frequency analysis operations) on the pilot control signal(s) to generate one or more transformed signals, and determine the pilot command signal based on the transformed signal(s). In some examples, the flight controller 120 may use one or more trained machine learning models to perform the signal processing operation(s) on pilot control signal(s) and/or sensor signal(s) to generate commands for various components of aircraft 100.

As described above, in some cases, the flight controller unit 120 may determine one or more command signals for controlling the aircraft 100 and/or a trajectory generated for the aircraft 100 based on sensor data provided by the sensor(s) 122. The sensor(s) 122 may include vision sensor(s), depth sensor(s) (e.g., LiDAR sensor(s)), torque sensor(s), gyroscope(s), accelerometer(s), magnetometer(s), inertial measurement unit(s) (IMU(s)), pressure sensor(s), force sensor(s), proximity sensor(s), displacement sensor(s), vibration sensor(s), environmental sensor(s), and/or the like.

The flight controller 120 may further be configured to provide a variety of control signals to the motor assemblies 106 to control their respective lift rotors 108 and/or push propellers 110. For example, the flight controller 120 may cooperate with one or more controllers of the motor assemblies 106 to provide an enable signal to enable the operation (e.g., active powered operation) of the motor assemblies 106.

The motor assemblies 106, as disclosed herein, may be configured to operate in a synchronized or closed loop manner, where the position of the motor is used as feedback to provide control signals (e.g., commutation signals) to the various phases of the motor. The motor assemblies 106 may also be configured to operate in an open loop manner, without position feedback. In open loop operation, the motor is only controlled using the commutation signals, without the benefit of positional feedback from the motor. When the motor is not powered, but still spinning, a back-electromotive force (EMF) is generated. The back-EMF is generally proportional to the angular velocity of the motor. Put another way, when commutation of a motor is interrupted for any reason, the motor, while spinning, will still produce a back-EMF opposing the motion of the motor.

It should be understood that in the context of the electric aircraft 100, an interruption on the operation of one or more of the motor assemblies 106 may result in unsafe, or at least non-ideal, operating conditions. Unexpected depowering of a motor assembly 106 may result in a loss of lift and/or a loss of thrust of the aircraft 100, resulting in possibly unsafe flying conditions. Thus, it is desirable to quickly reboot and/or restart a motor assembly 106 that has unexpectedly stopped operating.

According to examples of the disclosure, a motor assembly 106 may be configured to reboot after being deenergized. Furthermore, the motor assembly 106 may be configured to reboot while the aircraft 100 is still in flight, or otherwise operational. According to systems and methods of the disclosure, the phase voltage of two of the phases of the motor may be measured while the motor is deenergized, but still spinning due to rotational inertia from previously being powered. As disclosed herein, the phase voltages arises due to back-EMF generated from a magnetic field (e.g., magnetic field from a permanent magnet of a rotor of the motor) moving through a coil (e.g., wire coils of a stator of the motor). The measured phase voltage can then be applied to one or more mathematical operations (e.g., Clarke transform, dq0 transform, Arctan of the ratio of the phase voltages, etc.) to determine a position of the motor. The position of the motor, as used herein, refers to the position of the rotor of the motor relative to the stator. It should be understood that the position of the motor may be referred to by any other suitable terms, such as rotor position, motor angle, rotor angle, motor phase, rotor phase, or the like.

It should be understood that the motor assemblies 106 may not include a position sensor. The control mechanisms and related control laws may not use a position sensor for synchronization of the motor assembly 106. Instead, the motor assembly, and the synchronization thereof, may be controlled using back-EMF and/or current and/or voltage measurements at the various phases of the motor assembly 106.

In some cases, the motor may not be spinning or may not be spinning at a sufficient velocity to measure accurate phase voltages. In this case, the motor may first be spun-up in an open loop operation, prior to reengaging synchronized, closed loop operation. In other words, the motor may be spun up to a sufficient rotational velocity before determining the phase voltages to reengage commutation of the motor in a synchronized manner. For example, the threshold rotational speed may be in the range of about 20 RPM to about 200 RMP. In other cases, the threshold rotational speed may be in the range of about 50 RMP to about 100 RPM. In one example, the threshold rotational speed may be about 70 RPM. If the motor is spinning at a speed under the threshold rotational speed, the phase voltage measurements and/or the rotor position measured therefrom may lack precision and/or accuracy.

Although discussed in the context of the eVTOL aircraft 100, it should be understood that the apparatus, systems, and methods disclosed herein to reboot the motors assemblies 106 may be applied to any suitable application. For example, the mechanism for rebooting motors may be applied to a conventional takeoff and landing (CTOL) aircraft or other transportation vehicles. The CTOL may include one or more propulsion motors located in the front, rear, or along the wings of the aircraft that may need to be rebooted during flight using the mechanisms disclosed herein.

FIG. 2 is a schematic illustration of an example motor assembly 106 of the eVTOL aircraft 100 of FIG. 1, according to examples of the disclosure. The motor assembly 106 may include a motor 200. The motor 200 may be the component that provides rotational motion from the motor assembly 106 for any variety of purposes, such as to rotate the lift rotors 108 and/or the push propellers 110. The motor 200 may be of any suitable type, such as a permanent magnet synchronous motor (PMSM). Alternatively, the motor 200 may be any suitable DC or AC motor, such as brushed, brushless, synchronous, induction, switched-reluctance, or the like. The motor 200 may have any suitable topology and/or number of phases. For example, the motor 200 may have three phases that are separated by 120° (2π/3 radians). Alternatively, the motor may have six phases that are separated by 60° (π/3 radians). Indeed, the motor 200 may have any suitable number of phases, split-phases, or the like.

The motor assembly 106 includes an inverter 202 that provides power to the motor 200. The inverter 202 may include hardware and software that cooperate to provide power to the motor 200 as commutation signals. Commutation signals, as used herein, refer to signals that provide both timing and power to the motor 200 to enable the motor 200 to rotate. The inverter 202 may include switched power electronics, such as metal-oxide-semiconductor field effect transistors (MOSFETs) 204 or other transistors or switches. The MOSFETs 204 may be arranged as various legs (not shown) of the inverter 202, where each leg provides commutation signals to each phase of the stators of the motor 200. In other words, the MOSFETs 204 may be switched in such a manner as to energize the phases of the motor 200 in succession to rotate the motor 200. The commutation signals from the MOSFETs 204 may be in any suitable form, such as pulse width modulated (PWM).

The inverter 202 may include current sensor(s) 206 and voltage sensor(s) 208. The current sensor(s) 206 may also be referred to as current meters and are configured to measure the current (I_{A}, I_{B}, and I_{C}) provided to each of the phases (A, B, and C) of the motor 200. The current sensor(s) 206 may provide the current (I_{A}, I_{B}, and I_{C}) measurements as a series of values with time. Similarly, the voltage sensor(s) 208 may also be referred to as voltage meters and are configured to measure the voltage (V_{A}, V_{B}, and V_{C}) at each of the phases (A, B, and C) of the motor 200. The voltage sensor(s) 208 may provide the voltage (V_{A}, V_{B}, and V_{C}) measurements as a series of values with time. Although a three phase motor 200 is discussed here, it should be understood that motor 200 may be of any suitable number of phases. The number of phase currents and phase voltages measured may depend on the number of phases of the motor 200.

The inverter 202 may further include an inverter controller 210, also referred to as motor controller 210 or controller 210, that provides the timing and current control 212 to the MOSFETs 204 of the inverter 202. Thus, it is the controller 210 that enables the inverter 202 and the motor assembly 106 to operate in a closed loop operation, using feedback, such as timing feedback, in controlling the motor 200. The controller 210 may determine the motor position via a position estimator 214 function within the controller 210. The functionality of the position estimator 214 may rely on a back-EMF observer 216 functionality within the controller 210. The back-EMF observer 216 may determine the back-EMF from the motor 200 based at least in part on the current measurements received from the current sensors 206. The back-EMF observer 216 in cooperation with the position estimator 214 allows for the estimate of the position of the motor 200.

The controller 210 uses, at least in part, the position estimate from the position estimator 214 to provide current control 212 to the MOSFETs 204 to commutate the motor 200. For example, the controller 210 may determine, from the motor position estimate, when the second phase is to be deenergized and the third phase is to be energized. Then the controller 210 may generate the corresponding current control 212 signals to deenergize the second phase and energize the third phase of the motor 200. Continuing further with this example, the current control 212 provided to the MOSFETs 204 may cause the MOSFETs 204 to shunt a stator coil of the motor 200 corresponding to the second phase to ground and shunt a stator coil of the motor 200 corresponding to the third phase to a current or power source. In this way, the controller 210 provides current control 212 to the MOSFETs 204 to selectively energize and deenergize the phase coils of the motor 200 in a rotating manner to physically rotate the motor 200. The control signals 212 may be provided to the gates (e.g., the control terminal) of the MOSFETs 204 in a selective and synchronized manner to turn on or off individual ones of the MOSFETs 204. It should be understood that switches, other than MOSFETs 204, may be used to power the motor 200 and be similarly controlled by the inverter controller 210. For example, switches such as insulated gate field effect transistors (IGFETs), bipolar junction transistors (BJTs), or the like may be used in place of, or in conjunction with, the MOSFETs 204.

During normal synchronized operation, the controller 210 operates the motor in a closed loop operation, where feedback from the motor 200 is used to control the motor 200. Closed loop operation, making use of feedback and position estimates, is a more robust form of motor 200 control than open loop operation, where feedback is not used for motor 200 control. The inverter 202 provides commutation to the motor 200 using the position estimation. Closed loop operation of the motor 200 may further depend, at least in part, on commands received from the flight controller 120. For example, the flight controller 120 may instruct the inverter 202 to speed up the motor 200 or increase a torque generated by the motor. In this case, the controller 210 may speed up the motor 200, such as by increasing the frequency of commutation of the motor 200. Similarly, the controller 210 may be able to slow down the motor 200 or reduce a torque generated by the motor based at least in part on command(s) received from the flight controller 120.

During synchronized operation of the motor 200, an unexpected condition (e.g., lightning, solar storm, etc.) may cause the inverter 202 to lose synchronization with the motor 200. When this happens, the inverter 202 may stop providing power to the motor 200. At this point the motor 200 may still be spinning, but may not be powered. Because the motor 200 is still spinning, there is a voltage associated with each of the motor's phases due to back-EMF. Thus, the voltage sensors 208 are able to measure the various phase voltages (V_{A}, V_{B}, and/or V_{C}) of the motor. The controller 210 may receive the phase voltage measurements from the voltage sensors 208 and use those phase voltage values to determine an initial position estimate. The controller 210 may determine the motor position using the following equation (in radians):

$$Θ = {tan}^{- 1} ( {V}_{B} / {V}_{A} ) - π / 2 \qquad Equation 1$$

Where V_{B} and V_{A} are phase voltages of two of the phases of motor 200 and tan⁻¹ is the Arctangent or inverse tangent function.

According to examples of the disclosure, once the controller 210 determines the initial position estimate, using an initial position estimator 218, of the motor 200, the inverter 202 can reinstate powering the motor 200 using commutation signals from the MOSFETs 204. The aforementioned mechanism for determining the motor position and rebooting the motor 200 can be performed while the aircraft 100 is still in flight. Furthermore, the mechanism for rebooting the motor 200 may be performed relatively quickly (e.g., few seconds or less). In some cases, the reboot may take less than 1 second to perform. For example, the reboot may take between about 50 ms and about 500 ms. Thus, rebooting the motor 200, as disclosed herein, may mitigate safety concerns with losing motor power while in flight. For example, any of the motor assemblies 106 and their corresponding lift rotors 108 and/or push propeller 110 may be unintentionally unpowered for a relatively short period of time.

In some cases, the motor 200 may be unpowered long enough for the motor 200 to stop rotating or to rotate below a threshold rotational speed. In these cases, the back-EMF from the motor 200 may be insufficient to accurately and/or precisely measure the phase voltages (V_{A}, V_{B}, and V_{C}). Therefore, if the motor 200 rotates below a threshold rotational speed, then the motor 200 may first be spun up and/or sped up prior to measuring the phase voltages and using the phase voltages to determine, using the initial position estimator 218, the initial position estimate of the rotor relative to the stator of the motor 200. In this case, the motor 200 may initially be operated in an open loop fashion, where the current control 212 from the controller 210 is not based on the real-time position of the motor 200. Rather, the motor 200 is accelerated without considering feedback or without the benefit of the position estimation. Once the motor 200 reaches a threshold velocity in open loop operation, open loop operation of the motor 200 may be terminated. After open loop acceleration, the aforementioned processes of measuring phase voltages and using Equation 1, by the initial position estimator 218 function of the controller 210, to determine the initial position estimate may be performed. In some examples, driving voltage and current is temporarily stopped to obtain the voltage measurements for the rotor position calculation and then driving voltage is re-applied as part of the initialization of the motor control.

As disclosed herein, the threshold rotational speed may be in the range of about 20 RPM to about 200 RMP. In other cases, the threshold rotational speed may be in the range of about 50 RMP to about 100 RPM. In one example, the threshold rotational speed may be about 70 RPM. If the motor is spinning at a speed under the threshold rotational speed, the phase voltage measurements and/or the rotor position measured therefrom may lack precision and/or accuracy

It should further be understood that while only two of the phase voltages are used by the initial position estimator 218 to determine the initial position estimate, the phase voltages used are not limited to V_{A} and V_{B}. Rather, any two phase voltages may be used to determine the initial position estimate. For example, V_{B} and V_{C} or V_{C} and V_{A} may be used instead of V_{A} and V_{B}. In this disclosure, V_{A} and V_{B} are used as representative of any two phase voltages of the motor 200.

The process of rebooting the motor 200 may involve a variety of control signals between the flight controller 120 and the inverter controller 210 or within either of the flight controller 120 and/or the inverter controller 210. For example, the flight controller 120 may provide an ENABLE signal to command the inverter controller 210 to operate the motor 200. The inverter controller 210 may provide acknowledgement messages and/or status messages to the flight controller 120. The inverter controller 210 may have one or more internal ENABLE signals and/or activating signals.

It should be understood that the disclosure herein enables the reboot of a motor 200 of the aircraft 100 mid-flight in a safe and reliable manner. The apparatus, systems, and methods disclosed allow for greater reliability and safety of aircrafts, such as electric aircrafts 100. The disclosure allows the resynchronization of the drive or commutation signals of the MOSFETs 204 of the inverter 202 to power the motor 200. The mechanism disclosed herein may be performed in a matter of seconds or less, greatly reducing unpowered and/or uncontrolled motor operation.

As the eVTOL aircraft 100 is operating, such as flying in the sky, one or more of its motors 200 may stop being energized and/or synchronized. This situation may make for unsafe flying conditions. Using the mechanisms disclosed herein, the inverter controller 210 and/or the flight controller 120 may recognize that the motor(s) 200 are no longer being powered. It may further be determined by the inverter controller 210 that the motor(s) 200 are to be powered again. This may be determined based at least in part on ENABLE and/or other signals from the flight controller 120. The inverter controller 210 may then determine a rotor position based on the phase voltage measurements, as disclosed herein. Once the rotor position is determined for each motor 200, the motor 200 may be rebooted to be powered in a synchronized manner. The inverter 202, using the rotor position, may reengage the motor 200 in a synchronized fashion by generating synchronized commutation signals. This process may be relatively quickly performed, to prevent significant loss of lift and/or propulsion of the eVTOL aircraft 100.

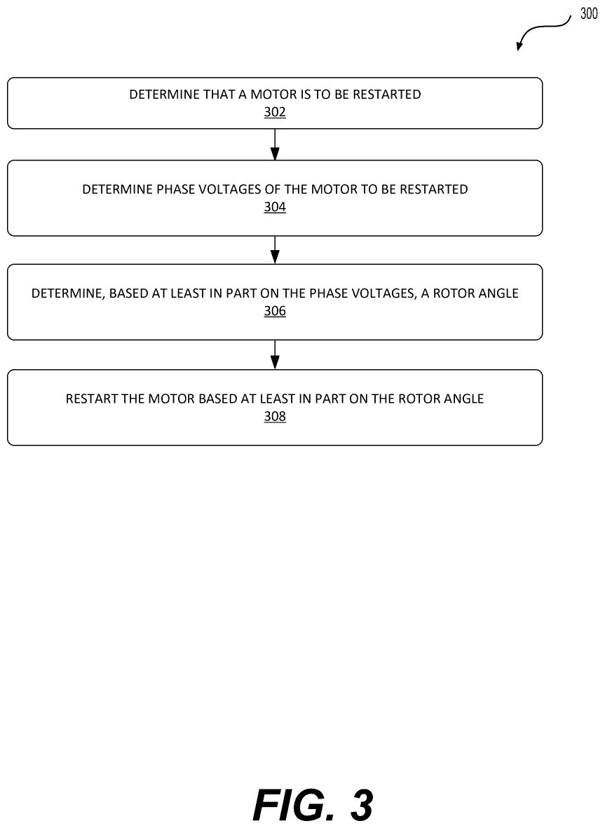

FIG. 3 is a flow diagram depicting an example method 300 for rebooting a motor 200 of the eVTOL aircraft 100 of FIG. 1, according to examples of the disclosure. The processes of method 300 may be performed by the controller 210, individually or in conjunction with one or more other elements of the inverter 202, such as voltage sensors 208. Method 300 allows the controller 210 to reboot the motor 200 in a synchronized manner when not being powered. According to examples of the disclosure, method 300 may be performed while the aircraft 100 is in flight.

At block 302, the controller 210 may determine that a motor 200 is to be restarted. The controller 210, in some cases, may be instructed by the flight controller 120 to restart its corresponding motor 200. In other cases, the controller 210 may detect that synchronization and/or commutation of the motor 200 has ended when the same should be continuing. In either case (e.g., receiving an instruction to reboot the motor 200 or self-detect a need to reboot the motor 200), the controller 210 identifies the need to restart the motor 200, sometimes when the motor 200 is still spinning and/or while the aircraft 100 is still in flight.

At block 304, the controller 210 may determine the phase voltages of the motor 200 to be restarted. In some cases, the controller 210 may receive the phase voltages of the various phases of the motor 200 from the voltage sensor(s) 208. For example, the controller 210 may periodically receive phase voltage data from the voltage sensor(s) 208 at a fixed or variable frequency. In other words, the controller 210 may receive, from the voltage sensor(s) 208, a time series of phase voltage values corresponding to individual ones of the phases of the motor 200. In other cases, the controller 210 may request the phase voltage data from the sensor(s) 208 and the sensor(s) 208 may send the requested phase voltage data to the controller 210 responsive to the request for the same.

At block 306, the controller 210 may determine a rotor angle based at least in part on the on the phase voltages. Any suitable mechanism may be used to determine the rotor angle from the phase voltage data. For example, Equation 1 may be used to determine the rotor angle. The rotor angle may be calculated from any two phase voltages of the motor. For example, V_{B} and V_{C} or V_{C} and V_{A} may be used instead of V_{A} and V_{B}. In this disclosure, V_{A} and V_{B} are used as representative of any two phase voltages of the motor 200.

At block 308, the controller 210 may restart the motor 200 based at least in part on the rotor angle. Once the rotor angle is known the controller 210 may command the MOSFETs 204 via current control 212. The controller 210 may determine, based at least in part on the rotor position, which of the phases of the motor 200 are to be energized. As the motor 200 rotates the controller 210 provides the current control signals 212 to control the commutation signals from the MOSFETs 204 to the motor 200.

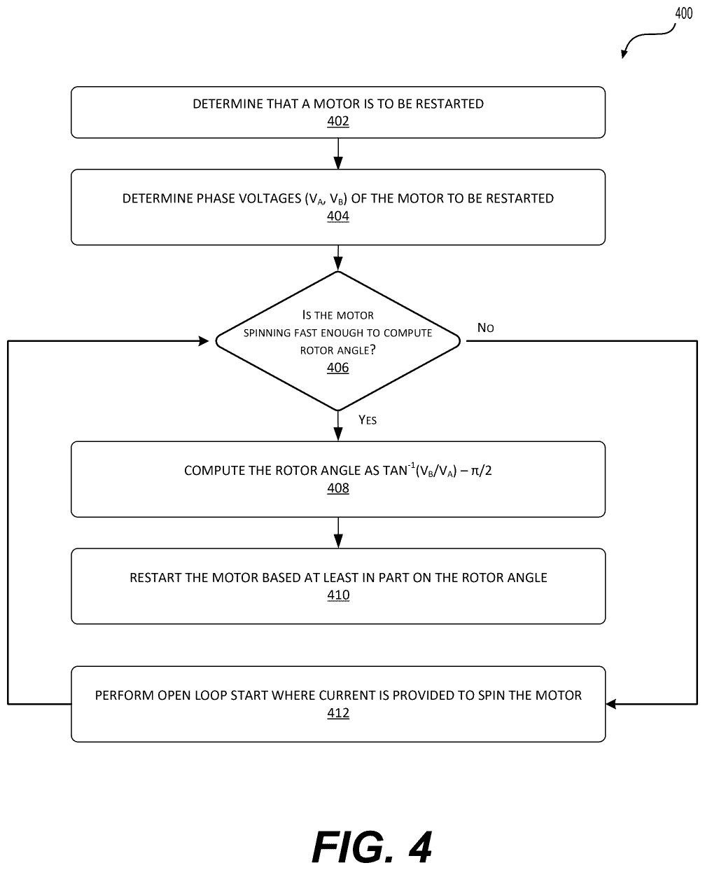

As disclosed herein, the method 300 enables a quick reboot of the motor 200 by using voltage measurements from the voltage sensor(s) 208 to find an initial position of the motor 200. It is this initial position of the motor 200 that is used to resynchronize the delivery of the power to the motor 200 from the MOSFETs 204. It is assumed in method 300 that the motor 200 is spinning fast enough, while unpowered, for reliable phase voltage measurements, which in turn, are used to determine the initial position of the motor 200. The case of when the motor 200 may not be spinning at a sufficient speed to enable reliable phase voltage measurements and/or motor position calculations is discussed in conjunction with FIG. 4.

It should be noted that some of the operations of method 300 may be performed out of the order presented, with additional elements, and/or without some elements. Some of the operations of method 300 may further take place substantially concurrently and, therefore, may conclude in an order different from the order of operations shown above.

FIG. 4 is a block diagram depicting another example method for rebooting a motor of the eVTOL of FIG. 1, according to examples of the disclosure. The processes of method 400 may be performed by the controller 210, individually or in conjunction with one or more other elements of the inverter 202, such as voltage sensors 208. Method 400 allows the controller 210 to reboot the motor 200 in a synchronized manner when not being powered. According to examples of the disclosure, method 400 may be performed while the aircraft 100 is in flight.

At block 402, the controller 210 may determine that a motor 200 is to be restarted. The controller 210, in some cases, may be instructed by the flight controller 120 to restart its corresponding motor 200. In other cases, the controller 210 may detect that synchronization and/or commutation of the motor 200 has ended when the same should be continuing. In either case (e.g., receiving an instruction to reboot the motor 200 or self-detect a need to reboot the motor 200), the controller 210 identifies the need to restart the motor 200, sometimes when the motor 200 is still spinning and/or while the aircraft 100 is still in flight.

At block 404, the controller 210 may determine the phase voltages of the motor 200 to be restarted. In some cases, the controller 210 may receive the phase voltages of the various phases of the motor 200 from the voltage sensor(s) 208. For example, the controller 210 may periodically receive phase voltage data from the voltage sensor(s) 208 at a fixed or variable frequency. In other words, the controller 210 may receive, from the voltage sensor(s) 208, a time series of phase voltage values corresponding to individual ones of the phases of the motor 200. In other cases, the controller 210 may request the phase voltage data from the sensor(s) 208 and the sensor(s) 208 may send the requested phase voltage data to the controller 210 responsive to the request for the same.

At block 406, the controller 210 may determine if the motor 200 is spinning fast enough for reliable phase voltage measurements and/or to compute the rotor angle of motor 200. The motor spin speed can be determined based at least in part on the phase voltages measured during the operations of block 404. In some cases, the motor rotational speed may be equal to the frequency of the measured phase voltage a phase of the motor. For example, if a phase voltage, measured as a series of measurement values, indicates a frequency of 10 kilohertz (kHz), then the motor 200 may also be spinning with a rotational speed of 10 kHz. In other cases, the motor 200 may have a speed that is a multiple of the phase voltage measurements. The determined motor speed may be compared to a threshold value to determine if a reliable motor position can be determined from the motor speed. If the motor speed is greater than the threshold speed value, then the method 400 may proceed to block 408. Otherwise, the method 400 may proceed to block 412.

At block 408, the controller 210 may determine a rotor angle based at least in part on the on the phase voltages. Any suitable mechanism may be used to determine the rotor angle from the phase voltage data. For example, Equation 1 may be used to determine the rotor angle. The rotor angle may be calculated from any two phase voltages of the motor 200. For example, V_{B} and V_{C} or V_{C} and V_{A} may be used instead of V_{A} and V_{B}. In this disclosure, V_{A} and V_{B} are used as representative of any two phase voltages of the motor 200.

At block 410, the controller 210 may restart the motor 200 based at least in part on the rotor angle. Once the rotor angle is known the controller 210 may command the MOSFETs 204 via current control 212. The controller 210 may determine, based at least in part on the rotor position, which of the phases of the motor 200 are to be energized. As the motor 200 rotates the controller 210 provides the current control signals 212 to control the commutation signals from the MOSFETs 204 to the motor 200.

If, at block 406, it was determined that the motor speed is insufficient to reliably compute the motor position, then at block 412, the controller 210 may perform an open loop start. Open loop operation of the motor 200 is less reliable than closed loop operation of the motor 200, as back-EMF observation is not used to control commutation of the motor 200. However, open loop operation can allow for the inverter 202 to increase the speed of the motor 200 to beyond a threshold speed that allows for reliable determination of the motor position. Therefore, the inverter controller 210 generates open loop current control for the MOSFETs 204, which in turn provide commutation signals to the motor 200 to operate in open loop and speed up beyond the threshold voltage at which reliable motor position calculations may be made. At this point, the method 400 may return to block 406 to determine if the motor 200 has sped up enough in open loop operation to enable the determination of the rotor angle. If at block 406, it is determined that the motor 200 is spinning at a sufficient speed to reengage the motor 200 in closed loop operations, then the operations of blocks 408 and 410 may be performed to reboot the motor 200.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

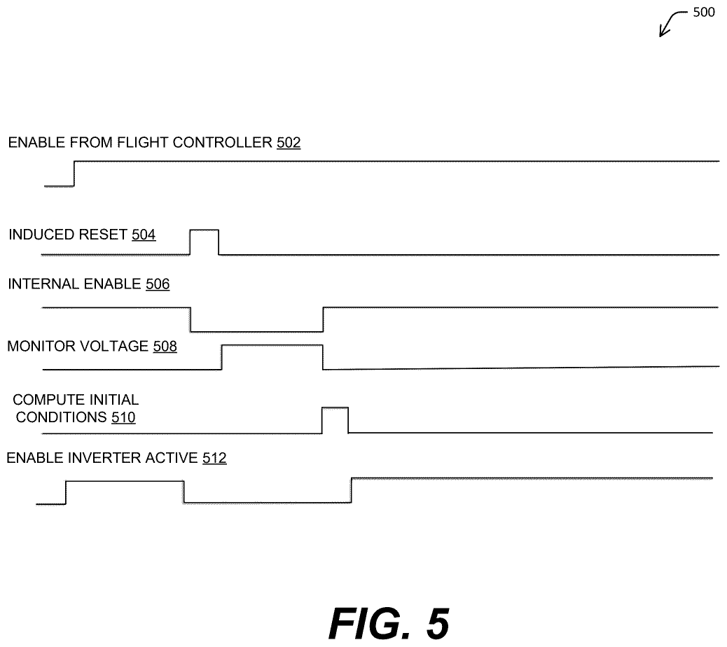

FIG. 5 is a signal timing diagram 500 depicting various signals involved in rebooting the motor 200 of the eVTOL aircraft 100 of FIG. 1, according to examples of the disclosure. It should be understood that the signals shown here are representative of signaling associated with the motor 200 reboot and the disclosure contemplates more, fewer, and/or other signals in the reboot of the motor 200. The reboot of the motor 200 may involve any variety of signals between the flight controller 120 and the inverter controller 210 or within the inverter controller 210. As shown here, a high signal indicates activation of a corresponding action associated with that signal. It should be understood that the opposite could alternatively be implemented, where a low signal corresponds to activation of a corresponding action associated with that signal.

As depicted, the flight controller 120 may provide an enable signal 502 to the inverter controller 210. The enable signal 502 may indicate to the inverter controller 210 that the motor 200 is to be powered. Thus, if the inverter controller 210 identifies that the enable signal 502 indicates that the motor 200 is to be powered, but the inverter controller 210 is not providing power (e.g., commutation signals) to the motor 200, then the motor 200 is to be reboot, as disclosed herein. There may be an induced reset signal 504 that indicates to the inverter controller 210 that the commutation signals, and therefore power, to the motor 200 has been disrupted. Thus, when the induced reset signal 504 is detected and the enable signal 502 is active, the inverter controller 210 identifies that the motor 200 is to be reboot. It should be understood that the inverter controller 210 may identify a lack of power being provided from the inverter 202 to the motor 200 using any other variety of mechanisms, such as checking if commutation signals are being provided from the MOSFETs 204 or if current control signals 212 are not being generated.

The inverter controller 210 may further have an internal enable signal 506 that indicates that the motor 200 is not being powered. Thus, the internal enable signal 506 may be low when the inverter 202 is not providing power to the motor 200. When the motor 200 is rebooted and power is being provided to the motor 200 in a normal manner (e.g., closed loop operation), the internal enable signal 506 may be high. While the internal enable signal 506 is low, the reboot operations, as disclosed herein, may be conducted.

The motor voltage may be monitored 508, as depicted, while the internal enable signal 506 is low. It is during this monitor voltage 508 period that the phase voltages of the motor 200 are determined for subsequent computation of the initial conditions 510. In other words, the phase voltages are measured while the monitor voltage 508 is shown high. Next the motor controller 210 computes the motor angle while the compute initial conditions 510 is high. At this point, the initial motor angle is known and can be used to reboot the motor 200, at which point, an enable inverter active signal is set high.

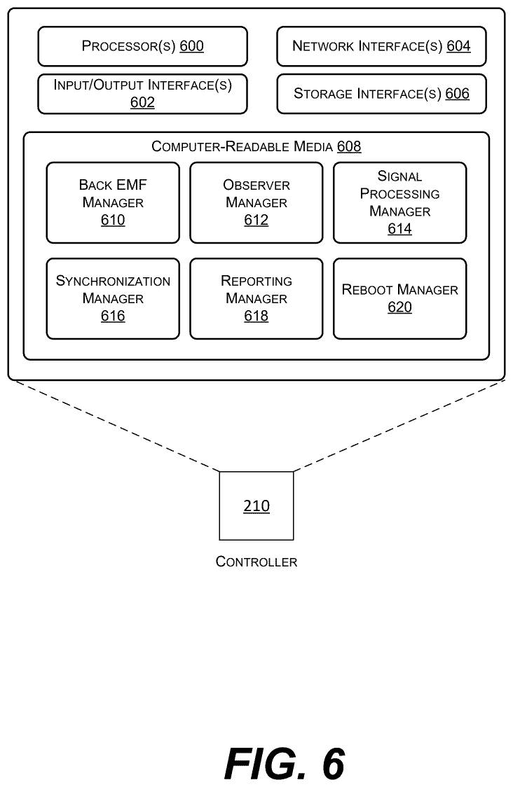

FIG. 6 is a block diagram of the controller 210 of the inverter of FIG. 2, according to examples of the disclosure. The controller 210 includes one or more processor(s) 600, one or more input/output (I/O) interface(s) 602, one or more communication interface(s) 604, one or more storage interface(s) 606, and computer-readable media 608. In examples, the processor(s) 600, I/O interfaces 602, communications interface(s) 604, storage interface(s) 606, and/or computer-readable media 608 may be part of an electronic device or computer system.

In some implementations, the processors(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 600 may possess its own local memory, which also may store program modules, program data, and/or one or more operating systems. The one or more processor(s) 600 may include one or more cores.

The one or more input/output (I/O) interface(s) 602 may enable the controller 210 to detect interaction with a human operator. For example, the operator may provide task instructions (e.g., intended flight maneuvers) or monitor metrics (e.g., motor speed, motor torque, etc.) from the inverter 202.

The network interface(s) 604 may enable the controller 210 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of WiFi, cellular radio, a wireless (e.g., IEEE 802.1x-based) interface, a Bluetooth® interface, and the like. Thus, the network interface(s) 604 may enable one or both of the control planes 118, 120.

The storage interface(s) 606 may enable the processor(s) 600 to interface and exchange data with the computer-readable media 608, as well as any storage device(s) external to the controller 210. The storage interface(s) 606 may further enable access to removable media.

The computer-readable media 608 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 608 may be implemented as computer-readable storage media (CRSM), which may be any available physical media accessible by the processor(s) 600 to execute instructions stored on the computer readable media 608. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 600. The computer-readable media 608 may have an operating system (OS) and/or a variety of suitable applications stored thereon. The OS, when executed by the processor(s) 600 may enable management of hardware and/or software resources of the controller 210.

Several components such as instruction, data stores, and so forth may be stored within the computer-readable media 608 and configured to execute on the processor(s) 600. The computer readable media 608 may have stored thereon a back EMF manager 610, an observer manager 612, a signal processing manager 614, a synchronization manager 616, a reporting manager 618, and a reboot manager 620. It will be appreciated that each of the components 610, 612, 614, 616, 618, 620 may have instructions stored thereon that when executed by the processor(s) 600 may enable various functions pertaining to operating the controller 210, as described herein.

The instructions stored in the back EMF manager 610, when executed by the processor(s) 600, may configure the controller 210 to monitor back EMF for the purposes of closed loop motor control. The controller 210 may use back EMF to track the position of the motor 200 to provide current control 212 to the MOSFETs 204, which in turn provides commutation signals the motor 200. The instructions stored in the observer manager 612, when executed by the processor(s) 600, may configure the controller 210 to observe the back EMF, as measured while the motor 200 spins. Thus, the controller 210 is able to use the back EMF measurements to enable feedback control.

The instructions stored in the signal processing manager 614, when executed by the processor(s) 600, may configure the controller 210 to process current and/or voltage data as received from current sensor(s) 206 and/or voltage sensor(s) 208. The signals, as received, may be processed and interpreted by the controller 210 to control the motor 200. Additionally, signals may be received from the flight controller 120, by the inverter controller 210, for control of the motor 200. The instructions stored in the synchronization manager 616, when executed by the processor(s) 600, may configure the controller 210 to synchronize commutation signals to the motion of the motor, as disclosed herein. Thus, the controller may use voltage measurements to determine current control 212 for the MOSFETs 204.

The instructions stored in the reporting manager 618, when executed by the processor(s) 600, may configure the controller 210 to report any loss of motor control to the flight controller 120 and/or to a human pilot. The controller 210 may also report when it has rebooted the motor 200 by the mechanism disclosed herein. The instructions stored in the reboot manager 620, when executed by the processor(s) 600, may configure the controller 210 to manage the rebooting process, as disclosed herein. The controller 210 may determine whether the motor 200 is spinning fast enough and them operate the motor in either a closed loop fashion, or alternatively, first in an open loop fashion and then in a closed loop fashion, as disclosed herein.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

### EXAMPLE CLAUSES

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

Clause A: In an aspect of the present disclosure, a motor controller includes one or more processors and one or more computer-readable media storing computer-executable instructions that, when executed by the one or more processors, cause the one or more processors to determine that a motor is lacking commutation. The one or more processors further determine that the motor is to be commutated, receive, from one or more voltage sensors, a first phase voltage value associated with a first phase of the motor, and receive, from the one or more voltage sensors, a second phase voltage value associated with a second phase of the motor. The one or more processors still further determine, based at least in part on the first phase voltage value and the second phase voltage value, a motor position associated with the motor, generate, based at least in part on the motor position, current control signals for one or more switches, wherein the one or more switches generate commutation signals for the motor, and provide the current control signals to the one or more switches.

Clause B: The motor controller is further configured to determine the motor position, in radians, as an arctangent of a ratio of the first phase voltage value to the second phase voltage value minus π/2.

Clause C: The motor controller is further configured to receive, from a flight controller, an enable signal indicating that the motor is to be commutated.

Clause D: The motor controller is further configured to determine, based at least in part on the first phase voltage value, that the motor is spinning at a speed greater than a threshold speed and determine, based at least in part on the motor spinning at a speed greater than the threshold speed, the motor position.

Clause E: The motor controller is further configured to determine, at a second time after providing the current control signals, that the motor is lacking commutation, determine that the motor is to be commutated, receive, from the one or more voltage sensors, a third phase voltage value associated with the first phase of the motor, determine, based at least in part on the third phase voltage value, that the motor is spinning at a speed less than a threshold speed, and initiate, based at least in part on determining that the motor is spinning at less than a threshold speed, open loop operation of the motor.

Clause F: The motor controller is further configured to receive, from the one or more voltage sensors, a fourth phase voltage value associated with the first phase of the motor, determine, based at least in part on the fourth phase voltage value, that the motor is spinning at a speed greater than the threshold speed, receive, from the one or more voltage sensors, a fifth phase voltage value associated with the second phase of the motor, determine, based at least in part on the fourth phase voltage value and the fifth phase voltage value, a second motor position associated with the motor, generate, based at least in part on the second motor position, second current control signals for the one or more switches, and provide the second current control signals to the one or more switches.

Clause G: The motor controller is further configured to receive current measurements associated with the motor from a current sensor and operate, based at least in part on the current measurements, the motor in closed loop operation.

Clause H: In another aspect of the present disclosure, a method includes determining, by a motor controller, that a motor is lacking commutation, receiving, by the motor controller and from one or more voltage sensors, a first phase voltage value associated with a first phase of the motor, and determining, by the motor controller and based at least in part on the first phase voltage value, a motor speed of the motor. The method further includes determining, by the motor controller, that the motor speed is less than a threshold speed and determining, by the motor controller and based at least in part on the motor speed being less than the threshold speed, that the motor is to be operated in open loop operation. The method still further includes generating, by the motor controller, current control signals for open loop operation of the motor and providing, by the motor controller and to one or more switches, the current control signals, wherein the one or more switches generate commutation signals to power the motor based at least in part on the current control signals.

Clause I: The method includes receiving, by the motor controller and from the one or more voltage sensors, a second phase voltage value associated with the first phase of the motor, determining, by the motor controller and based at least in part on the second phase voltage value, a second motor speed of the motor, determining, by the motor controller, that the second motor speed is greater than the threshold speed, and initiating, by the motor controller and based at least in part on the motor speed being greater than the threshold speed, closed loop operation of the motor.

Clause J: The method includes receiving, by the motor controller and from the one or more voltage sensors, a third phase voltage value associated with a second phase of the motor, determining, by the motor controller and based at least in part on the second phase voltage value and the third phase voltage value, a motor position associated with the motor, generating, by the motor controller and based at least in part on the motor position, second current control signals for closed loop operation of the motor, and providing, by the motor controller and to the one or more switches, the second current control signals.

Clause K: The method includes determining, by the motor controller, the motor position, in radians, as an arctangent of a ratio of the second phase voltage value to the third phase voltage value minus π/2.

Clause L: The method includes receiving, by the motor controller and from a flight controller, an enable signal indicating that the motor is to be commutated.

Clause M: In yet another aspect of the present disclosure, an aircraft includes a flight controller, a motor assembly including a motor, one or more switches configured to provide commutation signals to the motor, and a motor controller configured to control the motor assembly, and one or more voltage sensors communicatively coupled to the motor controller. The motor controller is configured to receive an enable signal from the flight controller indicating that the motor is to be commutated and determine that the motor is lacking commutation. The motor controller is further configured to receive, from the one or more voltage sensors, a first phase voltage value associated with a first phase of the motor and receive, from the one or more voltage sensors, a second phase voltage value associated with a second phase of the motor. The motor controller is still further configured to generate, based at least in part on the first phase voltage value and the second phase voltage value, current control signals for the one or more switches, wherein the one or more switches generate commutation signals for the motor based at least in part on the current control signals and provide the current control signals to the one or more switches.

Clause N: The aircraft, where the one or more switches comprise one or more metal-oxide-semiconductor field effect transistors (MOSFETs).

Clause O: The aircraft, where the motor controller is configured to determine, based at least in part on the first phase voltage value and the second phase voltage value, a motor position associated with the motor, wherein the current control signals are based at least in part on the motor position.

Clause P: The aircraft, where the motor controller is configured to determine the motor position, in radians, as an arctangent of a ratio of the first phase voltage value to the second phase voltage value minus π/2.

Clause Q: The aircraft, where the aircraft comprises an electric vertical take-off and landing (eVTOL) aircraft.

Clause R: The aircraft includes a second motor assembly including a second motor, a second one or more switches configured to provide second commutation signals to the second motor, and a second motor controller configured to control the second motor assembly and a second one or more voltage sensors communicatively coupled to the second motor controller, wherein the second motor controller is configured to determine that the second motor is lacking commutation. The second motor controller is further configured to receive, from the second one or more voltage sensors, a third phase voltage value associated with a first phase of the second motor, determine, based at least in part on the third phase voltage value, a motor speed of the second motor, determine that the motor speed is less than a threshold speed, determine, based at least in part on the motor speed being less than the threshold speed, that the motor is to be operated in open loop operation, generate second current control signals for open loop operation of the second motor, and provide, to the second one or more switches, the second current control signals.

Clause S: The aircraft, where the second motor controller is further configured to receive, from the second one or more voltage sensors and after providing the second current control signals to the one or more switches, a fourth phase voltage value associated with the first phase of the second motor and determine, based at least in part on the fourth phase voltage value, a second motor speed of the second motor. The second motor controller is further configured to determine that the second motor speed is greater than the threshold speed, determine, based at least in part on the second motor speed being greater than the threshold speed, that the motor is to be operated in closed loop operation, generate third current control signals for closed loop operation of the second motor, and provide, to the second one or more switches, the second current control signals.

Clause T: The aircraft, where the second motor controller is further configured to receive, from the second one or more voltage sensors and after providing the second current control signals to the one or more switches, a fifth phase voltage value associated with a second phase of the second motor and determine a motor position of the second motor based at least in part on the fourth phase voltage value and the fifth phase voltage value, wherein the second current control signals are based at least in part on the motor position of the second motor

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A motor controller, comprising:
one or more processors;
one or more computer-readable media storing computer-executable instructions that, when executed by the one or more processors, cause the motor controller to:
determine that a motor is lacking commutation;
determine that the motor is to be commutated;
receive, from one or more voltage sensors, a first phase voltage value associated with a first phase of the motor;
receive, from the one or more voltage sensors, a second phase voltage value associated with a second phase of the motor;
determine, based at least in part on the first phase voltage value and the second phase voltage value, a motor position associated with the motor;
generate, based at least in part on the motor position, current control signals for one or more switches, wherein the one or more switches generate commutation signals for the motor; and
provide the current control signals to the one or more switches.

2. The motor controller of claim 1, wherein the computer-executable instructions, when executed by the one or more processors, further cause the motor controller to:
determine the motor position, in radians, as an arctangent of a ratio of the first phase voltage value to the second phase voltage value minus π/2.

3. The motor controller of claim 1, wherein the computer-executable instructions, when executed by the one or more processors, further cause the motor controller to:
receive, from a flight controller, an enable signal indicating that the motor is to be commutated.

4. The motor controller of claim 1, wherein the computer-executable instructions, when executed by the one or more processors, further cause the motor controller to:
determine, based at least in part on the first phase voltage value, that the motor is spinning at a speed greater than a threshold speed; and
determine, based at least in part on the motor spinning at a speed greater than the threshold speed, the motor position.

5. The motor controller of claim 1, wherein the computer-executable instructions, when executed by the one or more processors, further cause the motor controller to:
determine, at a second time after providing the current control signals, that the motor is lacking commutation;
determine that the motor is to be commutated;
receive, from the one or more voltage sensors, a third phase voltage value associated with the first phase of the motor;
determine, based at least in part on the third phase voltage value, that the motor is spinning at a speed less than a threshold speed; and
initiate, based at least in part on determining that the motor is spinning at less than a threshold speed, open loop operation of the motor.

6. The motor controller of claim 5, wherein the computer-executable instructions, when executed by the one or more processors, further cause the motor controller to:
receive, from the one or more voltage sensors, a fourth phase voltage value associated with the first phase of the motor;
determine, based at least in part on the fourth phase voltage value, that the motor is spinning at a speed greater than the threshold speed;
receive, from the one or more voltage sensors, a fifth phase voltage value associated with the second phase of the motor;
determine, based at least in part on the fourth phase voltage value and the fifth phase voltage value, a second motor position associated with the motor;
generate, based at least in part on the second motor position, second current control signals for the one or more switches; and
provide the second current control signals to the one or more switches.

7. The motor controller of claim 6, wherein the computer-executable instructions, when executed by the one or more processors, further cause the motor controller to:
receive current measurements associated with the motor from a current sensor; and
operate, based at least in part on the current measurements, the motor in closed loop operation.

8. A method, comprising:
determining, by a motor controller, that a motor is lacking commutation;
receiving, by the motor controller and from one or more voltage sensors, a first phase voltage value associated with a first phase of the motor;
determining, by the motor controller and based at least in part on the first phase voltage value, a motor speed of the motor;
determining, by the motor controller, that the motor speed is less than a threshold speed;
determining, by the motor controller and based at least in part on the motor speed being less than the threshold speed, that the motor is to be operated in open loop operation;
generating, by the motor controller, current control signals for open loop operation of the motor; and
providing, by the motor controller and to one or more switches, the current control signals, wherein the one or more switches generate commutation signals to power the motor based at least in part on the current control signals.

9. The method of claim 8, further comprising:
receiving, by the motor controller and from the one or more voltage sensors, a second phase voltage value associated with the first phase of the motor;
determining, by the motor controller and based at least in part on the second phase voltage value, a second motor speed of the motor;
determining, by the motor controller, that the second motor speed is greater than the threshold speed; and
initiating, by the motor controller and based at least in part on the motor speed being greater than the threshold speed, closed loop operation of the motor.

10. The method of claim 9, further comprising:
receiving, by the motor controller and from the one or more voltage sensors, a third phase voltage value associated with a second phase of the motor;
determining, by the motor controller and based at least in part on the second phase voltage value and the third phase voltage value, a motor position associated with the motor;
generating, by the motor controller and based at least in part on the motor position, second current control signals for closed loop operation of the motor; and
providing, by the motor controller and to the one or more switches, the second current control signals.

11. The method of claim 10, further comprising:
determining, by the motor controller, the motor position, in radians, as an arctangent of a ratio of the second phase voltage value to the third phase voltage value minus π/2.

12. The method of claim 8, further comprising:
receiving, by the motor controller and from a flight controller, an enable signal indicating that the motor is to be commutated.

13. A aircraft comprising:
a flight controller;
a motor assembly including a motor, one or more switches configured to provide commutation signals to the motor, and a motor controller configured to control the motor assembly;
one or more voltage sensors communicatively coupled to the motor controller, wherein the motor controller is configured to:
receive an enable signal from the flight controller indicating that the motor is to be commutated;
determine that the motor is lacking commutation;
receive, from the one or more voltage sensors, a first phase voltage value associated with a first phase of the motor;
receive, from the one or more voltage sensors, a second phase voltage value associated with a second phase of the motor;
generate, based at least in part on the first phase voltage value and the second phase voltage value, current control signals for the one or more switches, wherein the one or more switches generate commutation signals for the motor based at least in part on the current control signals; and
provide the current control signals to the one or more switches.

14. The aircraft of claim 13, wherein the one or more switches comprise one or more metal-oxide-semiconductor field effect transistors (MOSFETs).

15. The aircraft of claim 13, wherein the motor controller is configured to:
determine, based at least in part on the first phase voltage value and the second phase voltage value, a motor position associated with the motor, wherein the current control signals are based at least in part on the motor position.

16. The aircraft of claim 15, wherein the motor controller is configured to:
determine the motor position, in radians, as an arctangent of a ratio of the first phase voltage value to the second phase voltage value minus π/2.

17. The aircraft of claim 13, wherein the aircraft comprises an electric vertical take-off and landing (eVTOL) aircraft.

18. The aircraft of claim 13, further comprising:
a second motor assembly including a second motor, a second one or more switches configured to provide second commutation signals to the second motor, and a second motor controller configured to control the second motor assembly;
a second one or more voltage sensors communicatively coupled to the second motor controller, wherein the second motor controller is configured to:
determine that the second motor is lacking commutation;
receive, from the second one or more voltage sensors, a third phase voltage value associated with a first phase of the second motor;
determine, based at least in part on the third phase voltage value, a motor speed of the second motor;
determine that the motor speed is less than a threshold speed;
determine, based at least in part on the motor speed being less than the threshold speed, that the motor is to be operated in open loop operation;
generate second current control signals for open loop operation of the second motor; and
provide, to the second one or more switches, the second current control signals.

19. The aircraft of claim 18, wherein the second motor controller is further configured to:
receive, from the second one or more voltage sensors and after providing the second current control signals to the one or more switches, a fourth phase voltage value associated with the first phase of the second motor;
determine, based at least in part on the fourth phase voltage value, a second motor speed of the second motor;
determine that the second motor speed is greater than the threshold speed;
determine, based at least in part on the second motor speed being greater than the threshold speed, that the motor is to be operated in closed loop operation;
generate third current control signals for closed loop operation of the second motor; and
provide, to the second one or more switches, the second current control signals.

20. The aircraft of claim 19, wherein the second motor controller is further configured to:
receive, from the second one or more voltage sensors and after providing the second current control signals to the one or more switches, a fifth phase voltage value associated with a second phase of the second motor; and
determine a motor position of the second motor based at least in part on the fourth phase voltage value and the fifth phase voltage value, wherein the second current control signals are based at least in part on the motor position of the second motor.
